(19) United States
(12) Patent Application Publication
(10) Pub. No.: US 2007/0164251 A1
(43) Pub. Date: Jul. 19, 2007

(54) High-temperature metal-organic acceptor magnets

(75) Inventors: Rajsapan Jain, Oakville (CA); Robin Gary Hicks, Victoria (CA)

Correspondence Address: KLARQUIST SPARKMAN, LLP, 121 SW SALMON STREET, SUITE 1600, PORTLAND, OR, 97204, US

(73) Assignees: University of Victoria Innovation; Development Corporation

(21) Appl. No.: 11/525,514

(22) Filed: Sep. 22, 2006

Related U.S. Application Data
(60) Provisional application No. 60/719,758, filed on Sep. 22, 2005.
(60) Provisional application No. 60/737,542, filed on Nov. 16, 2005.

(51) Int. Cl. C07F 15/04; C07F 15/06; H01F 1/00

(52) U.S. Cl. 252/62.51 R; 552/294

(57) ABSTRACT

A stable magnet having a high Tc is provided. The stable magnet is synthesized from an at least one ion of a metal from a metal-containing precursor and molecules of an organic compound in a metal to organic ratio of at least about 1 ion to 1 organic molecule and as much as 10 or more ions to 1 organic molecule. The metal-containing precursor provides at least one ion having a valency lower than its maximum valency state. The organic molecules are selected from a group of organic compounds having a reduction potential suitable to accept at least one electron from the metal ion and an at least one functional group that is able to coordinate with the metal ion.

### CROSS REFERENCE TO RELATED APPLICATION

The present application claims the benefit of U.S. provisional patent application Ser. No. 60/719,758, filed Sep. 22, 2005, and U.S. provisional patent application Ser. No. 60/737,542, filed Nov. 16, 2005. Both of these provisional applications are incorporated herein by reference in their entireties.

### FIELD

The present embodiment relates to the field of magnetic materials. More specifically the present embodiment is to magnets that have high Tc, and methods of preparation of the magnets.

### BACKGROUND

Since the advent of time, magnets have attracted the attention of mankind from scholastic and pragmatic perspectives. For over two decades there have been intense efforts aimed at the development of so-called “molecule-based” magnets, i.e. materials exhibiting spontaneous magnetization which are comprised in part or wholly of organic or molecular components (1-2). Although there are many so-called “molecule-based” materials exhibiting spontaneous magnetic ordering, few of these magnetically order above liquid nitrogen temperature (77 K) (3) and examples of magnetically ordered molecular materials at or near room temperature are extremely rare.

The only other room temperature molecule-based magnet is V(TCNE)ₓ.yCH₂Cl₂ (x≈2; y≈0.5) in which V(II) ions are presumably connected by TCNE radical anions (4). This compound is unstable in air and is but one member of a large family of low temperature MR₂ type magnets, i.e. metal (II) cations with organic radical anions in a 1:2 ratio (5). The generally accepted structural model alludes to a coordination framework material (though structural proof is still lacking for these systems) (6). Magnetic cooperativity is thought to arise from exchange interactions between spins localized on the metal ion and spins on the TCNE radical anion (4-5). All of unknown structure and are air-sensitive.

Vanadium-based materials have the highest T_{C}'s −200 K, 205, and 240 K (6-7) and the prototypal V(TCNE)₂ remains a magnet up to its thermal decomposition point (350 K) (4). Other metal (Fe, Co, Mn, Ni) ions give rise to TCNE based materials with lower (generally <122K) ordering temperatures (8-9). Of these, nickel-based magnets have relatively low T_{C}'s, and are made by either the reaction of zero-valent nickel reagent with neutral organic via electron transfer (T_{C}=13 K) (10) or ion exchange (metathesis) reactions of Ni(II) and radical anion salts (T_{C}=44 K) (8). In fact Ni(TCNX)₂ (X=E, Q) have a long history as metal-organic conductors and magnets, varying methods of synthesis affording low T_{c} products but all are strictly based on the NiR₂ model (8, 10, 11) with the exception of Willet's work on relatively rich Ni phases (12) which do not support magnetic order.

Much of the relevant prior art for most molecule based magnets known to date alludes to coordination based networks in which metal ions are presumably linked together by 4-6 acceptor molecules (depending on the metal used). By virtue of this these materials are implicitly “organic rich”. The metals are present in the +2 oxidation state and the 2 organic acceptors per metal are therefore always rationalized to be in the −1 oxidation state for the purposes of charge balance. Built around this structural model, the overall and central representation defining these materials is the MR₂ one i.e. comprising “organic rich” magnetic phases. Such parameters have heavily proposed the use of the conventional 1:2 (M:A) reaction ratios. This approach has exhaustively proven its inefficacy to predict much less produce high Tc molecule based magnets. It is an object of the embodiment to overcome the deficiencies in the prior art.

### SUMMARY

The present embodiment provides a class of magnetic materials comprising metal ions and organic molecules. These materials are high Tc magnets and possess a metal-to-organic ratio that differs from conventional metal/organic based magnets.

In one embodiment, the magnet comprises Nickel ions and organic molecules in a 2:1 (M:R) stoichiometry. The reactions of nickel bis(1,5-cyclooctadiene) with oxidizing agents such as TCNE, TCNQ or DDQ afford products that exhibit field-dependent magnetization and hysteresis at and above room temperature. The M:A composition is 2:1 and the spectroscopic signatures of A imply a radical anion (TCNE or TCNQ) or dianion (DDQ). Magnetic characterization suggests a glassy magnetic state apart from high Tc magnetic behavior.

In another embodiment, a stable magnet having a high Tc, synthesized from an at least one ion of a metal from a metal-containing precursor and molecules of an organic compound in a metal to organic ratio is provided. The metal to organic ratio is at least about 1 ion to 1 organic molecule, the metal-containing precursor provides at least one ion having a valency lower than its maximum valency state, and the molecules are selected from a group of organic compounds having a reduction potential suitable to accept at least one electron from the metal ion and an at least one functional group that is able to coordinate with the metal ion. In one aspect of the magnet embodied, high Tc is defined as greater than about 250 K.

In another embodiment a stable magnet having a Tc greater than about 250 K comprising metal ions from a metal-containing precursor and molecules of an organic compound is provided, wherein the metal ion is provided at a valency lower than its maximum valency state, and the molecules are selected from a group of organic compounds having a reduction potential suitable to accept at least one electron from the metal ion and an at least one functional group that is able to coordinate with the metal ion.

In another embodiment, a magnet having a high Tc, synthesized from metal ions of a metal-containing precursor and organic molecules having a conjugated framework is provided, in a metal to organic ratio. The metal to organic ratio is at least about 1 ion to 1 organic molecule on an ion to molecule basis, the ions are selected from Nickel (Ni), and Cobalt (Co), in valencies lower than their maximum valency state, and the organic compounds are selected from the group consisting of organic compounds having functional groups that are able to coordinate or bond with the metal ion. In one aspect of the magnet embodied, high Tc is defined as greater than about 250 K.

In one aspect of the magnet embodied, high Tc is defined as greater than about 300K.

In another aspect of the magnet embodied, the reduction potential ranges from about −1.15V to at least about +0.9V.

In another aspect of the magnet embodied, the reduction potentials range from about −0.7V to at least about +0.9V.

In another aspect of the magnet embodied, the organic compound is further defined as a conjugated organic compound.

In another aspect of the magnet embodied, the organic compounds are selected from the group consisting of polynitrile organic acceptors and quinone organic acceptors.

In another aspect of the magnet embodied, the polynitrile organic acceptors are selected from the group consisting of 7,7,8,8-Tetracyanoquinodimethane (TCNQ) and derivatives thereof, Tetracyanoethylene (TCNE), N,N′-Dicyanoquinone Diimine (DCNQI) and derivatives thereof, hexacyanodivinylbenzenes, dicyanostilbenes, and phenyltricyanoethylenes wherein the derivatives comprise R.sub.1-R.sub.5 and are selected independently from H, C.sub.1-c.sub.20, aromatic groups, CN, F, Cl, Br, I, NO.sub.2, COOH, COOR, CHO wherein R is C.sub.1-C.sub.20, OH, OR, wherein R is C.sub.1-C.sub.20, and heteroaromatics comprising N, O, P, or S and the quinone organic acceptors are selected from the group consisting of 1,4 benzoquinone derivatives, 1,4 napthoquinone derivatives, diquinone derivatives and 1,2 benzoquinone derivatives, wherein the derivatives comprise R.sub.1-R.sub.6 and are selected independently from H, C.sub.1-c.sub.20, aromatic groups, CN, F, Cl, Br, I, NO.sub.2, COOH, COOR, CHO wherein R is C.sub.1-C.sub.20, OH, OR, wherein R is C.sub.1-C.sub.60, and heteroaromatics comprising N, O, P, or S.

In another aspect of the magnet embodied, the metal ion is selected from Nickel (Ni), and Cobalt (Co).

In another aspect of the magnet embodied, the metal ion is Nickel.

In another aspect of the magnet embodied, the metal ion to organic molecule ratio is about 2:1.

In another aspect of the magnet embodied, the organic molecule is selected from the group consisting of TCNE, 2,3-dichloro-5,6-dicyano-1,4-benzoquinone (DDQ), TCNQ and TCNQ derivatives, wherein the derivatives comprise R.sub.1-R.sub.4 and are selected independently from H, C.sub.1-c.sub.20, aromatic groups, CN, F, Cl, Br, I, NO.sub.2, COOH, COOR, CHO wherein R is C.sub.1-C.sub.20, OH, OR, wherein R is C.sub.1-C.sub.20, and heteroaromatics comprising N, O, P, or S.

In another aspect of the magnet embodied, the organic molecule is selected from the group consisting of TCNE, DDQ and TCNQ.

In another aspect of the magnet embodied, nickel and the organic molecule are in a final ratio of approximately 2:1 in the magnet.

In another embodiment, a method of preparing a stable magnet having a high Tc is provided. The method comprises reacting metal ions of a metal-containing precursor and molecules of an organic compound in a metal to organic ratio, wherein the metal to organic ratio is at least about 1 ion to 1 organic molecule, the metal ions are in a valency state lower than their maximum valency state, and the molecules are selected from a group of organic compounds having a reduction potential suitable to accept at least one electron from the metal ion and functional groups that are able to coordinate with the metal ion.

In one aspect of the method, high Tc is defined as greater than about 250 K.

In another aspect of the method, high Tc is defined as greater than about 300 K.

In another aspect of the method, the reduction potential ranges from about −1.15V to at least about +0.9V.

In another aspect of the method, the reduction protentials range from about −0.7V to at least about +0.9V.

In another aspect of the method, the organic molecule is further defined as a conjugated molecule.

In another aspect of the method, the organic compounds are selected from the group consisting of polynitrile organic acceptors and quinone organic acceptors.

In another aspect of the method, the polynitrile organic acceptors are selected from the group consisting of 7,7,8,8-Tetracyanoquinodimethane (TCNQ) and derivatives thereof, Tetracyanoethylene (TCNE), N,N′-Dicyanoquinone Diimine (DCNQI) and derivatives thereof, hexacyanodivinylbenzenes, dicyanostilbenes, and phenyltricyanoethylenes wherein the derivatives comprise R.sub.1-R.sub.5 and are selected independently from H, C.sub.1-c.sub.20, aromatic groups, CN, F, Cl, Br, I, NO.sub.2, COOH, COOR, CHO wherein R is C.sub.1-C.sub.20, OH, OR, wherein R is C.sub.1-C.sub.20, and heteroaromatics comprising N, O, P, or S and the quinone organic acceptors are selected from the group consisting of 1,4 benzoquinone derivatives, 1,4 napthoquinone derivatives, diquinone derivatives and 1,2 benzoquinone derivatives, wherein the derivatives comprise R.sub.1-R.sub.6 and are selected independently from H, C.sub.1-c.sub.20, aromatic groups, CN, F, Cl, Br, I, NO.sub.2, COOH, COOR, CHO wherein R is C.sub.1-C.sub.20, OH, OR, wherein R is C.sub.1-C.sub.60, and heteroaromatics comprising N, O, P, or S.

In another aspect of the method, the metal ion is selected Nickel (Ni), and Cobalt (Co).

In another aspect of the method, the metal ion is Nickel.

In another aspect of the method, the metal ion to organic molecule ratio is about 2:1.

In another aspect of the method the organic molecule is selected from the group consisting of TCNE, 2,3-dichloro-5,6-dicyano-1,4-benzoquinone (DDQ), TCNQ and TCNQ derivatives, wherein the derivatives comprise R.sub.1-R.sub.4 and are selected independently from H, C.sub.1-c.sub.20, aromatic groups, CN, F, Cl, Br, I, NO.sub.2, COOH, COOR, CHO wherein R is C.sub.1-C.sub.20, OH, OR, wherein R is C.sub.1-C.sub.20, and heteroaromatics comprising N, O, P, or S.

In another aspect of the method, the organic molecule is selected from the group consisting of TCNE, DDQ and TCNQ.

In another aspect of the method, nickel and the organic molecule are in a final ratio of about 2:1 in the magnet.

In another embodiment, a magnet having a Tc greater than 250K, comprising metal ions from a metal-containing precursors and organic molecules having a conjugated framework is provided. The ions are selected from Nickel (Ni), and Cobalt (Co), provided in valencies lower than their maximum valency state, and the organic compounds are selected from the group consisting of organic compounds having functional groups that are able to coordinate with the metal ion.

In one aspect of the magnet embodied, high Tc is defined as greater than about 300K.

In another aspect of the magnet embodied, the organic molecules have a reduction potential ranging from about −1.15V to at least about +0.9V.

In another aspect of the magnet embodied, the organic molecules have a reduction potential ranging from about −0.7V to at least about +0.9V.

In another embodiment, a method of preparing a magnet having a high Tc, comprising synthesizing the magnet from metal ions of a metal-containing precursor and organic molecules having a conjugated framework, in a metal to organic ratio, is provided. The metal to organic ratio is at least about 1 ion to 1 organic molecule on an ion to molecule basis, the ions are selected from Nickel (Ni), and Cobalt (Co), in valencies lower than their maximum valency state, and the organic compounds are selected from the group consisting of organic compounds having functional groups that are able to coordinate or bond with the metal ion.

In one aspect of the method, high Tc is defined as greater than about 250 K.

In another aspect of the method, high Tc is defined as greater than about 300K

In another aspect of the method, the organic molecules have a reduction potential ranging from about −1.15V to at least about +0.9V.

In another aspect of the method, the organic molecules have a reduction potential ranging from about −0.7V to at least about +0.9V.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1. Temperature dependence of field-cooled (25Oe) magnetization for 1-3. Solid lines are extrapolations.

FIG. 2. Magnetic hysteresis loops for 1 (-), 2(-), and 3 (-) at 300 K. (a) ±400 Oe. (b) ±50,000 Oe.

FIG. 3. Temperature dependence of the in-phase (χ′; left) and out-of-phase (χ″; right) ac susceptibility of 3 at different frequencies: 0.1 Hz, ▪; 1.0 Hz, ♦, 10.0 Hz, ℏ; 117.04 Hz, ●;946.97 Hz, ▪.

### TERMS AND ABBREVIATIONS:

Acronym Full Chemical Name(s)
DDQ 2,3-dichloro-5,6-dicyano-1,4-benzoquinone
TCNQ 7,7,8,8-Tetracyanoquinodimethane
TCNE Tetracyanoethylene
DPBQ 2,5-dipyrazole-1-yl-1,4-benzoquinone
PC para-chloranil or tetrachloro-1,4-benzoquinone
DCNNQ 2,3-dicyano-1,4-naphthoquinone
NDQ Naphthodiquinone
DCNDQ Dichloronaphthodiquinone
ADQ Anthradiquinone
OC ortho-chloranil or tetrachloro-1,2-benzoquinone
DCNQI N,N′-Dicyanoquinone Diimine

Ions of a metal or metal ions: The ions contemplated in the present embodiment are selected Nickel (Ni), and Cobalt (Co), and preferably nickel.

d-blocks metals Cobalt and nickel

High T_{C}: High T_{C} is defined as 0K<T_{C}<decomposition temperature of the material; preferably 100K<T_{C}<decomposition temperature, more preferably 200K<T_{C}<decomposition temperature and still more preferably 250K<T_{C}<decomposition temperature and most preferably 300K<T_{C}<decomposition temperature.

Stable magnet: A magnet that retains its magnetic properties in air below its thermal decomposition point.

Redox potentials of organic molecules for the production of high Tc magnets: The electron accepting ability of organic molecules is probed using standard, solution-based electrochemical methods (for example, cyclic voltammetry) with a three electrode configuration-the working electrode (glassy carbon); counter electrode (Pt wire); and reference electrode (Ag wire). The measurements are performed at room temperature in acetonitrile (solvent) with a supporting electrolyte, tetrabutylammonium tetrafluoroborate {[Bu₄N][BF₄]} (concentration: 0.1 Molar). The reduction potential values are reported, as per convention, relative to the potential of an internal standard {ferrocene/ferrocenium redox couple} which has a reduction potential (E¹_{1/2}) defined to be 0.00 Volts (V) under the above conditions (change suggested because we are making Ferrocene our reference material so it is by definition 0.00V). Most acceptors are capable of accepting more than one electron and therefore have more than one reduction potential value but the reduction potential range provided below is strictly based on the First Reduction Potential (E¹_{1/2}). Based on our findings, the reduction potential values for organic acceptors that are favorable towards the realization of high Tc magnets commence from E¹_{1/2}=−0.70 V, which is the lower limit and can be defined as the “optimum minimum redox potential”. The upper value is as high a positive value that can be inherently recorded in organic acceptors i.e. in principle this is limitless although realistically not. As an example, the strongest isolated organic electron acceptor known to date is tetracyano-1,4-benzoquinone (cyanil) with a E¹_{1/2}=+0.90 V in acetonitrile vs SCE. Poor electron acceptors that have values below −0.70V, for example −0.70V to −1.15V are borderline and may result in organic based magnets but lower than −1.15 V seem to not favor the formation of magnets. Therefore, organic molecules having a redox potential ranging from approximately −1.15V to at least +0.9V would be suitable for the production of high Tc molecular magnets.

Coordination parameters of organic molecules for the production of high Tc magnets: In addition to the reduction potential (electron accepting ability) of the organic acceptor, functional groups that are able to coordinate (make bonds) to a metal species are needed for the production of high Tc molecular magnets. These functional groups may be any of the following: cyano (C≡N; e.g in TCNE, TCNQ, DCNQI); carbonyl (C═O; e.g. in 1,4-benzoquinones); nitro (NO₂); additionally, heteroatoms like Nitrogen (N) (e.g. in pyrazine), Phosphorus (P) (e.g. in phosphines), and Sulphur (S) (e.g. in thiols, thioethers) present in any possible form in organic molecules and arranged in such a manner as to coordinate. The presence of at least two such functional groups(optimum coordination parameter) or a combination thereof seems necessary from the point of view of being able to link metals together, as would be known to one skilled in the art.

Metals for the production of high Tc magnets: High Tc magnets can be made with Vanadium. Only one isolated specimen is reported which is thought to be V(TCNE)ₓ.yCH₂Cl₂ (x≈2; y≈0.5) (J. M. Manriquez, G. T. Yee, R. S. McLean, A. J. Epstein, J. S. Miller, Science 252, 1415-1417 (Jun 7, 1991).). The overall structure is unknown and the material is unstable in air, therefore the magnet is not a stable magnet. Three other magnets have been derived for the same metal but their critical temperatures are sub-room temperature (<300 K)-ranging from 120K-240K (J. P. Fitzgerald, B. B. Kaul, G. T. Yee, Chemical Communications, 49-50 (2000). B. B. Kaul, G. T. Yee, Inorganica Chimica Acta 326, 9-12 (Dec 17, 2001). E. B Vickers, T. D. Selby, J. S. Miller, Journal of the American Chemical Society 126, 3716-3717 (2004)). Low Tc organic based magnets are known for other metals like Iron, Nickel, Cobalt, Manganese, Chromium but none of them have Tc's exceeding 121K (J. Zhang, J. Ensling, V. Ksenofontov, P. Gütlich, A. J. Epstein, J. S. Miller, Angewandte Chemie-International Edition 37, 657-660 (Mar 16, 1998).). For Nickel magnets Tc's are even lower (<45K). Other metals that are contemplated for the production of high Tc magnets in the present embodiment include, Nickel (Ni) and Cobalt (Co).

Characteristics of suitable metals for the production of high Tc magnets:

The low valency in the metal based starting material is more critical than the oxidation state of the metal in the end products, which is usually the most stable oxidation state, although not necessarily. The valency acquired in the end product is more of a consequence of the method, materials and conditions employed rather than a requirement. Thus, a basic criterion for suitable metal candidates as precursors is low valent states (lower than their individual-maximum achievable state). In these low valent states the metal precursors are relatively more electron rich as opposed to their oxidized states and, therefore, prone to donating electron(s) to good organic acceptors. Such electron transfers either before or after coordination to the organic acceptor is favorable for making magnets. In these metal precursors, groups attached to the metal prior to the start of the reaction should also be capable of dissociation (in part or whole) from the metal coordination environment in preference to the new, incoming acceptor group. In the case of {Ni(Cod)₂} we confirm that the cyclooctadiene (Cod) groups detach easily (and can be recovered in their uncoordinated form at the end of the reaction) thus rendering the metal free to coordinate with the acceptor. Concomitant electron transfers to the organic acceptors result in Ni ions of the +2 valency, its most favorable and common oxidation state. Other metal precursors should embody these criteria i.e. to begin with be low-valent, electron rich metal sources, capable of bonding to organic acceptors (or their reduced states) in preference to the groups already attached to them. Electron rich metal precursors for example, Co₂(CO)₈, fit these requirements. The starting metal valencies contemplated are zero.

Ratio of metal to organic compound for the production of high Tc magnets: For the reactions of {Ni(Cod)₂} with organic acceptors we have found that the most conducive metal (M) to organic acceptor (A) ratio is greater than 1 (M):1 (A) (range of ratios). Using the “preferred” 2:1 (Ni:A) ratio we have synthesized over a dozen magnets comprising of 2 Ni²⁺ ions per 1 organic acceptor ion (either in the −1 or −2 state). However, ratios other than 2:1 (M:A) could also result in magnets. The very upper limit of the metal stoichiometric ratio is dictated and limited by the challenges of not being able to rationalize charge balances and disadvantages of decomposition based impurities even though these ratios might afford new magnets. In line with that, we have also performed preliminary experiments using 3:1 and 4:1 (Ni(Cod)₂:Acceptor) ratios and found these ratios to result in magnets. At this point, these materials are not fully characterized and understood. With regard to valency and ratio relationships-the lower the starting valency the greater the chance for the use of a higher M:A ratio. The same arguments should hold toward other metal precursors and organic molecule ratios. Thus, the expected “preferred ratios” for other metals should also be greater than or equal to 1:1 (M:A), more specifically the ratio is from 1:1 to 10:1, including non-integer ratios, such as N.X:1, wherein N=1 to 10 and X=1 to 9, more specifically, N.XY:1 wherein N=1 to 10, X=1 to 9 and Y=1 to 9, still more specifically, a continuum of stoichiometries.

Ratio of metal to organic compound in high Tc magnets: The expected ratios for metals should be greater than or equal to 1:1 (M:A), more specifically the ratio is from 1:1 to 10:1, including non-integer ratios, such as N.X:1, wherein N=1 to 10 and X=1 to 9, more specifically, N.XY:1 wherein N=1 to 10, X=1 to 9 and Y=1 to 9, still more specifically, a continuum of stoichiometries.

Characteristics of organic molecules for the production of high Tc magnets:

These molecules are neutral. The requirement is the ability to coordinate (bond) through any of the mentioned functional groups—non-conjugated forms are also contemplated. Some generic classes of compounds that fall within this are depicted below. R groups may vary from alkyl chains or derivatives thereof comprising one carbon atom up to 20 carbon atoms. In addition, these R groups could be halogens (F, Cl, Br, I); cyano groups (C≡N); carboxylic acids and derivatives (COOH/COOR); hydroxyl (OH) and alkoxy (OR) groups; Nitro groups (NO₂); simply Hydrogen (H); or Nitrogen (N); Oxygen (O), Phosphorus (P), Sulphur (S) heteroatoms or derivatives thereof.

Representative classes of important organic acceptors
Polynitrile organic acceptors

| | | |
|---|---|---|
| 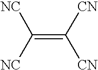 | 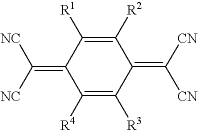 | 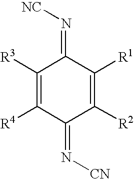 |
| TCNE | TCNQ and derivatives | DCNQI and |
| | | derivatives |

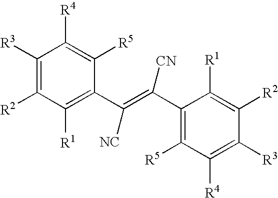

α,α′-dicyanostilbenes

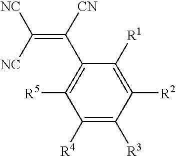

Phenyltricyanoethylenes

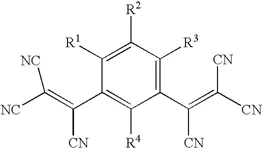

i-hexacyanodivinylbenzenes

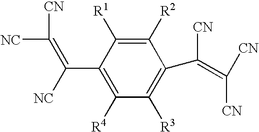

hexacyanodivinylbenzenes
Quinone organic acceptors

| | |
|---|---|
| 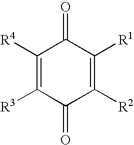 | 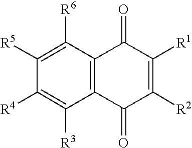 |
| 1,4-benzoquinone derivatives | 1,4-napthoquinone derivatives |
| 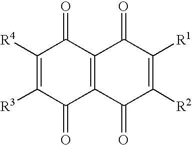 | 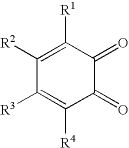 |
| diqulnones and derivatives | 1,2-benzoquinones |

R¹⁻⁶: H, C₁-C₂₀ alkyl groups, CN, F, Cl, Br, I, COOH, CHO, OH; N, P, S and derivatives thereof

R1-6 can be linear or branched aliphatic groups with the number of carbon atoms ranging from 1-20 for each R.

Relationship between experimental conditions and product recovery:

Experimental conditions are mild (room temperature) using non-coordinating solvents (such as (but not only) dichloromethane and chloroform) in the reactions so that the solvents are not competing for coordination to the metal center. The rigorous 10 exclusion of oxygen (O₂) and moisture (H₂O) or simply “air” using pre-dried glassware and dry argon or nitrogen based inert atmosphere using standard dry-box and Schlenk techniques is suitable to avoid the decomposition of starting materials and intermediate species and therefore allow for better product recovery. But depending on the system, organics or air can be introduced at a later stage of the reactions as ancillaries for completing the magnetic and structural framework of the material in question. Such is the case in our magnets where we have successfully employed various workups on the native {Ni₂A}ₙ framework by administering coordinating molecules through gentle hydrolysis (air exposure) or addition of organic linkers (e.g. pyrazine) to fulfill structural, coordination requirements of the metal sites and overall balance of charge.

### EXAMPLES

Reactions of nickel (0) bis(1,5-cyclooctadiene) {Ni(cod)₂} as an alternative to Ni(II) salts (8, 11) or nickel tetracarbonyl (10, 13) with non-innocent electron acceptors DDQ, TCNE and TCNQ (14) were undertaken. When carried out in the conventional 1:2 (Ni:A) ratio, an immediate reaction ensues as evidenced by the colour change, but low yields of impure products that appear to be non-magnetic at room temperature along with unreacted uncoordinated organics are obtained, all findings symptomatic of more complex dynamics at play than would be suspected. However, when the reactions are performed with the opposite M:A stoichiometry i.e. 2:1, and the highly air-sensitive solutions so produced are gently hydrolyzed or air exposed, dark (near black) materials precipitate from solution in quantitative yield (based on conversion of Ni or A), thus, consuming all the ligand (scheme 1). This was done with excellent repeatability.

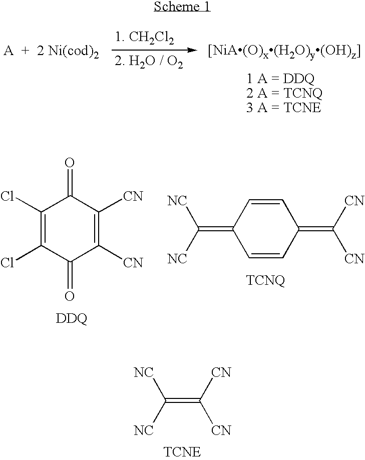

Analyses of the resulting black, insoluble, air-stable solids indicate that no cyclooctadiene (cod) is present in these materials (IR, elemental analyses); additional experiments demonstrated the quantitative recovery of uncoordinated cod from the reaction filtrates confirmed via ¹H NMR spectroscopy. Once prepared, no amounts of A, present in any permissible redox state could be extracted from these solids with other solvents. The basic stoichiometry of each of the three materials is “Ni₂A” where A equals one of the three organic molecules TCNE, TCNQ or DDQ with residual solvent. In addition there are water, or possibly oxide/hydroxide resulting from the hydrolysis-based (air exposure) work-up -whatever the form, the oxygen containing species is most likely bound to the nickel ions. Elemental analyses gave reproducible results, all have some amount of oxygen—in the possible forms of coordinated water, hydroxide and oxide, percentages varying from system to system but reproducible within a single one. The empirical compositions for the samples can be best formulated as [Ni₂A.(O)ₓ.(H₂O)_{y}.(OH)_{z}] (15). Powder x-ray diffraction patterns reveal all samples to be amorphous. Efforts to determine the precise electronic structure were thwarted by lack of structural information due to intrinsic morphology and the fact that one cannot convincingly tell the difference between analytically indistinguishable subgroups-(e.g., [H₂O+O²⁻] vs. [2OH⁻] in 1 or [H₂O+O²⁻+H^{31 1}] vs. [3OH^{-1] in} 2 and 3) Therefore, vibrational and solid state electronic spectra became vital to ascertain the nature of the organic acceptor.

For 2 and 3, infrared (IR) spectra are consistent with the radical anion (ν_{C}≡N) but for 1 there appears to be a dianion (ν_{C═O} (cm⁻¹): 1416 (s), ν_{C≡N}: 2236 (m)). Bathochromic shifts of >240 cm⁻¹ in the ν_{C═O} stretches arise from a fully reduced species (16). Broad ν_{C≡N} (cm⁻¹) stretches centered at 2191 (s) and 2205 (s), 2179 (m) in 2 and 3 respectively are in keeping with the radical anion and for 2 this is further established with a δ_{C—H} at 824 cm⁻¹ (m) (14, 17). Moreover, in all cases the ligands are presumably coordinated to Ni ions since ν_{C≡N} values do not correspond to any allowable redox states for “free”-TCNE, TCNQ (14, 18-19) or DDQ (20). Additionally, these IR characteristics differ from previously reported Ni(TCNX)₂ prepared from any synthetic route (8, 10, 11, 13) and all exhibit “clean”, singular CN stretches precluding the presence of degraded forms of the ligands which would possess their own characteristic stretches. All of this is further corroborated via characteristic long wavelength absorption bands (or the lack of them) in the electronic spectra (21) that show DDQ to be present as a dianion and definitely not a radical anion (16, 20). Initially, there seemed the prospect of DDQH⁻¹ (22) but this was decisively ruled out by observing identical electronic spectra of the materials isolated before {[Ni₂DDQ]ₙ} and after air exposure-there being no facile proton source prior to air exposure, implying no formation of DDQH⁻at any stage. Materials 2, 3 show electronic absorptions consistent with radical anions (23). Both before and after air exposure this remains true but there seem to be minor structural reorganization events on part of the ligand upon air exposure. In the XPS studies, binding energies for Ni 2p3/2 were observed at 856.4 (±0.1) eV in 1-3, values in the expected range for chemically stable Ni(II) centers bound to organo moieties; ruling out nickel (0), for which the Ni 2p_{3/2} peaks are typically around 853 eV. These data, however, must be interpreted with caution as the interaction between nickel-quinone and related ligands can lead to unusual oxidation states {Ni(I) (24), Ni(III) (25)}. Charge balance considerations therefore require anionic components additional to anionic A, probably metal-coordinated OH⁻or O²⁻, supported by elemental analyses. TGA measurements are consistent with water present and small amounts of residual CH₂Cl₂ owing to immediate weight loss upon heating, with no mass loss recorded beyond 600-645° C. (26).

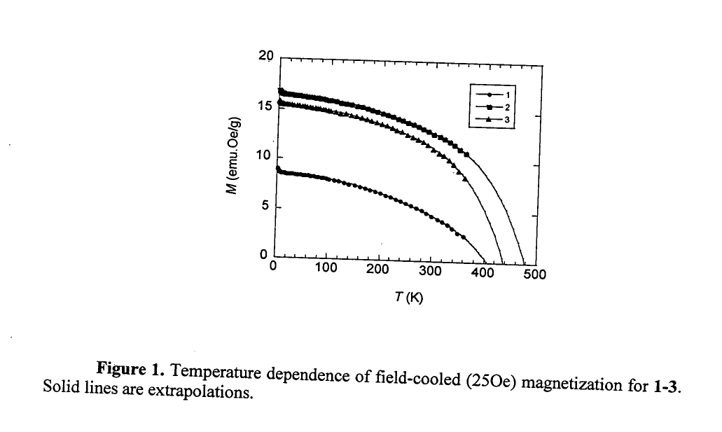

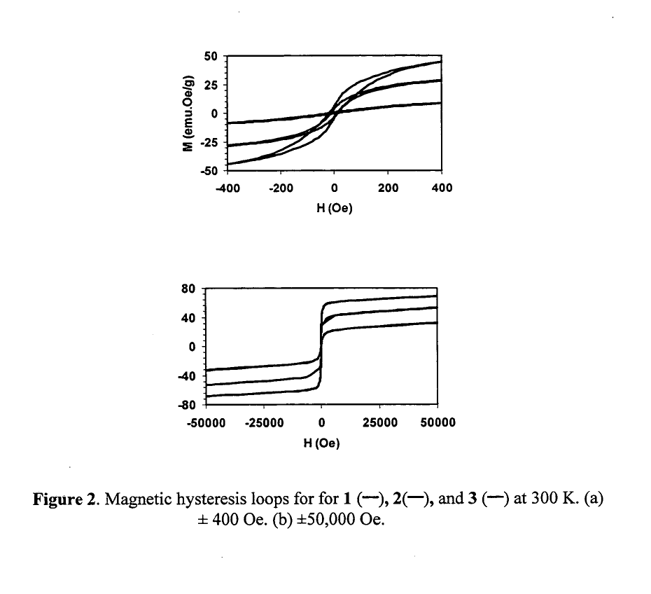

Results of magnetic studies show that the materials adhered to closely held external magnet, under ambient conditions, as bulk samples. Quantitative characterization was probed using a super conducting quantum interference device (SQUID) magnetometer Critical temperatures (Tc) are reported from the onset points (M(T)→0) derived by extrapolation in the field-cooled (FC) M(T) plots (5-7, 10) (FIG. 1) as approx. 405 K (1), 480 K (2) and 440K (3), in contrast to all low Tc Ni(TCNX)₂ magnetic materials known to date (8, 10, 11, 13) and these profiles are clearly dependent on the organic “A”. Magnetization vs. field plots at 300 K reveal that all three compounds exhibit spontaneous magnetization and distinctive hysteresis (FIGS. 2a-b), substantiating long-range bulk magnetic ordering at ambient temperature. Spontaneous magnetization behavior (FIG. 2b), expressed in gram-magnetization in the field-dependent plots was typical of real magnets. Qualitatively, all three samples have visibly different attractive responses to an external magnet. Coercive fields (H_{c}) and remanent magnetization (Mᵣ) of 1-3 at 300 K are tabulated (Table 1). The remanence of 1 (containing spin-inactive DDQ dianion) is an order of magnitude smaller than that of 2 or 3 (both contain spin-active (S=1/2) radical anions). Based on the observed coercive fields (10-15Oe), all three compounds are soft magnets.

TABLE 1
Magnetic parameters for 1-3.

| | T_{C} | H_{c} | Mᵣ | Mₛₐₜ |
|---|---|---|---|---|
| Compound | (K) | (Oe) | (emu · Oe · g⁻¹) | (emu · Oe · g⁻¹) |
| 1 | 405 | 12.9 | 0.46 | 32.2 |
| 2 | 480 | 14.0 | 5.49 | 68.6 |
| 3 | 440 | 12.4 | 3.69 | 52.9 |

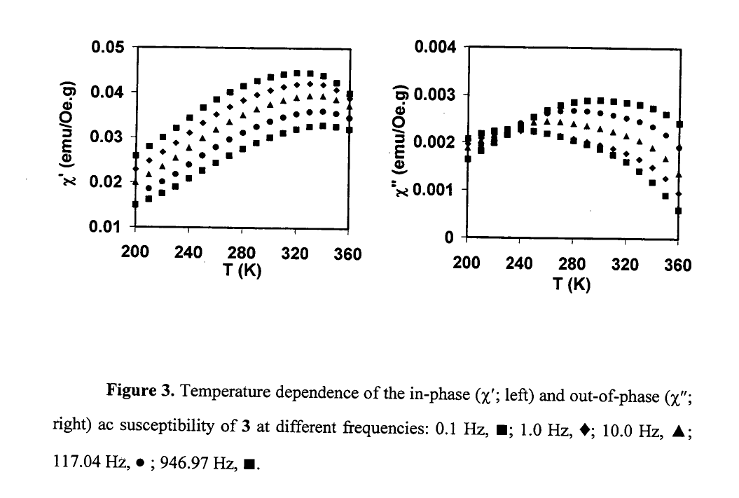

However, in the M (T) plots the departure of the field-cooled curve from the zero field-cooled profile below bifurcation temperatures (M_{FC}≠M_{ZFC}) of approximately 300K (1), 360 K (2) and 360K (3) recorded at H=25 Oe suggest the inception of spontaneous magnetization and a glassy state in these materials (11). The absence of complete saturation in the M(H) plots squares with the postulated glassy state. AC susceptibility measurements-χ′ (in-phase) and χ″ (out-of-phase) vs. T show finite values at high temperatures and are frequency dependent with shifting peak (freezing) temperatures. Gradual shifts to higher peak temperatures with increasing frequencies are characteristic of glassy magnet. FIG. 3 presents ac data for 3 as a representative example.

The presence of bulk Ni, a strong ferromagnet (T_{C}=627K), can be safely ruled out since the magnetic properties of our materials differ vastly. Furthermore, it is doubtful we have just Ni because of the oxidizing conditions leading to Ni (+2) ions, as supported by XPS studies which rule out sources of nickel (0), and the fact that the ligands are concomitantly reduced to the radical anion or dianion state. Moreover, the reaction does not produce magnetic materials when performed in donor solvents such as tetrahydrofuran or acetonitrile. Also the course of events are different when Ni(P(OR)₃)₄ is employed as starting material even in the “proposed” ratio, and the possibilities of bulk Ni have been adequately eliminated between Ni(CO)₄ and TCNX based reactions (10, 13). Furthermore, colloidal Ni is superparamagnetic, with blocking temperatures dependent upon surface species and size/aggregation effects. The materials reported herein have recorded magnetic properties reproducible within different batches, independent of particle size. Bulk NiO and Ni (OH) ₂ are antiferromagnets with T_{N}=573K and 24.8 K respectively and therefore pose as improbable possibilities. The possibility of pure NiO nanoparticles is also untenable since they are realized by entirely different synthetic routes-protocols that primarily stem from Ni (II) sources and usually involve annealing at very high temperatures. Besides, their magnetic properties are dissimilar to our candidates, displaying various anomalies within themselves and are contingent upon finite size effects fluctuating between antiferromagnetic behavior to those of superparamagnets (27). Besides, superparamagnets exhibit weak ordering only at very low temperatures. Even the use of Ni(Cod)₂ as a precursor to Ni nanoparticles requires special conditions/method to afford different type of magnetic materials (28) and so does its “sonochemical” driven decomposition (29).

These materials are unlike previous metal cation/radical anion based magnets. TCNQ and DDQ have not previously been incorporated into any high Tc magnets. Nickel salts of TCNE and TCNQ have been extensively studied, but none magnetically order above 44K. The materials described herein are distinguished by (1) their metal-to-organic ratio, which at 2:1 is the opposite of the conventional M(TCNX)₂ materials; (2) the fact that the organic acceptor plays a distinct role in determining the magnetic properties but does not necessarily have to be a radical anion to render high-T_{C} magnetic materials; (3) most importantly, their magnetic behavior, namely the existence of magnetization at and above room temperature.

A structural model for these materials remains wanting, but the compositional and magnetic data argue against the model developed for the MA₂ magnet (5-6), and the existence of several NiA₂ materials with T_{C}'s <50K suggest the materials described herein have a different (and new) structural basis. The spectroscopic features suggest that the organic ligands are sigma bound (via the nitrile or carbonyl groups) to the nickel. There is adequate precedent for sigma and pi modes in Mn complexes of p-quinones (30). Some Cu systems with similar structural traits have also been recently reported (31). The distinct magnetic properties of 1, 2 and 3 strongly suggest that the organic anions are not merely present for charge compensation but are integral to the magnetic structure of these materials.

Redox reactions appear to be key—reactions of Ni(cod)₂ with relatively poor oxidizing agents such as 1,4-benzoquinone and 1,4-naphthoquinone led to low yields of impure products that appear to be paramagnetic (not ordered) in nature. Again, no decomposition to bulk Ni was observed. Use of duroquinone led to the formation of discrete sandwich complexes already reported (32) and for p-anthraquinone, a poor acceptor, the unreduced, unreacted ligand was recovered in quantitative amounts. Since the redox potentials of the reagents cannot merely lead to electron transfer there could be some sort of pre-coordination event leading to an intermediate which then can undergo electron transfer (6-7). Another reason why it also appears necessary to have prior coordination is the use of coordinating solvents like tetrahydrofuran or acetonitrile thwarts the formation of 1-3, perhaps through solvent coordination to Ni (33).

The foregoing is a description of an embodiment. As would be known to one skilled in the art, variations are contemplated that do not alter the scope of the embodiment. For example, various ratios of metal to organic ligand are contemplated, as are a wide range of organic compounds and a wide range of metal ions. The use of various ratios in excess of 1:1 (M:A) can be employed for a wide range of potential good electron acceptors and metal precursors starting from their low valent oxidation state(s). Perhaps, this excess metal ratio can also be successfully utilized in preset high oxidation state metal precursors which have failed to produce high Tc magnets using the conventional ratios in prior art.

### REFERENCES AND NOTES

1. O. Kahn, MolecularMagnetism VCH-New York (1993).
2. J. S. Miller, Inorganic Chemistry 39, 4392-4408 (Oct 2, 2000). (An invited contribution from ACS award recipient)
3. J. S. Miller, A. J. Epstein, Mrs Bulletin 25, 21-28 (November 2000); J. S. Miller, A. J.

Epstein, Coordination Chemistry Reviews 206, 651-660 (September 2000).
4. J. M. Manriquez, G. T. Yee, R. S. McLean, A. J. Epstein, J. S. Miller, Science 252, 1415-1417 (Jun 7, 1991).
5. J. S. Miller, A. J. Epstein, Chemical Communications, 1319-1325 (Jul 7, 1998).
6. J. P. Fitzgerald, B. B. Kaul, G. T. Yee, Chemical Communications, 49-50 (2000).
7. E. B Vickers, T. D. Selby, J. S. Miller, Journal of the American Chemical Society 126, 3716-3717 (2004). Also refer to G. Yee's V[PTCE]₂ ferrimagnet (T_{c}=240K).
8. J. Zhang, J. Ensling, V. Ksenofontov, P. Gutlich, A. J. Epstein, J. S. Miller, Angewandte Chemie-International Edition 37, 657-660 (Mar 16, 1998).
9. K. I. Pokhodnya, N. Petersen, J. S. Miller, Inorganic Chemistry 41, 1996-1997 (Apr 22, 2002).
10. E. B Vickers, A. Senesi, J. S. Miller, Inorganica Chimica Acta 357, 3889-3894 (Aug 13, 2004).
11. R. Clerac, S. O'Kane, J. Cowen, X. Ouyang, R. A. Heintz, H. Zhao, M. J. Bazile Jr., K. R. Dunbar, Chemistry of Materials 15, 1840-1850 (May 6, 2003).
12. G. Long, R. D. Willett, Inorganica Chimica Acta 313, 1-14 (Feb 26, 2001). 13. E. B Vickers, I. D. Giles, J. S. Miller, Chemistry of Materials 17, 1667-1672 (March, 2005).
14. W. Kaim, M. Moscherosch, Coordination Chemistry Reviews 129, 157-193 (January, 1994).
15. Representative Elemental Analyses: A=DDQ: [C₈H₇O_{6.5}N₂Cl₂Ni₂.C_{0.15}H_{0.3}Cl_{0.3}]ₙ denoting [Ni₂(DDQ).(O). 3.5H₂O.(CH₂Cl₂)_{0.15}]ₙ or [Ni₂(DDQ).(O-H)₂.2.5H₂O.(CH₂CL₂) _{0.15}]ₙ Atom-Calc. (found): C, 22.44 (22.51); H, 1.69 (2.31); N, 6.42 (6.20); O, 23.84 (23.12); Cl, 18.69 (18.90). A=TCNQ: [C₁₂H₉O₄N₄Ni₂.C_{0.125}H_{0.25}Cl_{0.25}]ₙ denoting [Ni₂(TCNQ).(O).(OH).2H₂O.(CH₂Cl₂)_{0.125}]ₙ or [Ni₂(TCNQ).(O—H)₃. H₂O.(CH₂Cl₂)_{0.125}]ₙ Atom-Calc. (found): C, 36.30 (36.43); H, 2.32 (2.38); N, 13.96 (13.94); O, 15.95 (16.34); Cl, 2.21 (2.26). A=TCNE: [C₆H₅O₄N₄Ni₂.C_{0.125}H_{0.25}Cl_{0.25}] denoting [Ni₂(TCNE).(O).(OH).2H₂O.(CH₂Cl₂)_{0.125}]ₙ or [Ni₂(TCNE).(O-H)₃. H₂O. (CH₂Cl₂)_{0.125}]ₙ Atom-Calc. (found): C, 22.63 (22.95); H, 1.63 (1.72); N, 17.23 (17.10); O, 19.68 (18.42); Cl, 2.73 (2.73).
16 J. S. Miller, D. A. Dixon, Science 235, 871-873, (February 1987).
17. H. Zhao, R. A. Heintz, X. Ouyang, K. R. Dunbar, Chemistry of Materials 11, 736-746 (March 1999).
18. H. Hartmann, B. Sarkar, W. Kaim, J. Fiedler, Journal of Organometallic Chemistry 687, 100-107 (Dec 1, 2003) and references cited therein.
19. V. J. Murphy, D. O'Hare, Inorganic Chemistry 33, 1833-1841 (Apr 27, 1994) and references cited therein.
20. J. S. Miller, P. J. Krusic, D. A. Dixon, W. M. Reiff, J. H. Zhang, E. C. Anderson, A. J. Epstein Journal of the American Chemical Society 108, 4459-4466 (1986).
21. Performed in BaSO₄ (nm); A=DDQ: 205, 216, 247, 260, 403; A=TCNQ: 216, 265, 450, 665; A=TCNE: 266, 286, 293, 404.
22. E. Gerbert, A. H. Reis, J. S. Miller, Journal of the American Chemical Society 104, 4403-4410 (1982).
23. S. E. Bell, J. S. Field, R. J. Haines, M. Moscherosch, W. Matheis, W. Kaim, Inorganic Chemistry 31, 3269-3276 (Jul 22, 1992).
24. C. Benelli, A. Dei, D. Gatteschi, L. Pardi, Journal of the American Chemical Society 110, 6897-6898 (1988).
25. H. Ohtsu, K. Tanaka, Angewandte Chemie-International Edition 43, 6301-6303 (2004).
26. Temp.(° C.) (% wt. loss); A=DDQ: 170 (15.88), 368 (23.70), 630 (67.07), >630 (none); A=TCNQ: 169 (9.42), 356 (22.16), 441 (49.70), 602 (61.39), >602 (none); A=TCNE: 170 (9.43), 388 (22.12), 499 (42.60), 645 (53.02), >645 (none).
27. M. A. Khadar, V. Biju, A. Inoue, Materials Research Bulletin 38, 1341-1349 (2003) and references cited therein.
28. N. Cordente, M. Respaud, F. Senocq, M-J. Casanove, C. Amiens, B. Chaudret, Nano Letters 10, 565-568 (2001) and references (4, 14, 16, 17) cited therein.
29. Y. Koltypin, A. Fernandez, T. C. Rojas, J. Campora, P. Palma, R. Prozorov, A. Gedanken, Chemistry ofMaterials 11, 1331-1335 (April, 1999).
30. M. Oh, G. Carpenter, D. Sweigart, Accounts of Chemical Research 37, 1-11 (2004).
31. S. Masaoka, D. Tanaka, Y. Nakanishi, S. Kitagawa, Angewandte Chemie-International Edition 43, 2530-2534 (2004).
32. V. G. N. Schrauzer, H. Thyret, Zeitschrift Fur Naturforschung 17b, 73-76 (1962).
33. Pokhodnya, V. I., Pejakovic, D., Epstein, A. J., Miller, J. S. Phys. Rev. B 63, 174408 (2001).

We claim:

1. A stable magnet having a high Tc, synthesized from an at least one ion of a metal from a metal-containing precursor and molecules of an organic compound in a metal to organic ratio,
said metal to organic ratio being at least about 1 ion to 1 organic molecule,
said metal-containing precursor providing said at least one ion having a valency lower than its maximum valency state, and
said molecules selected from a group of organic compounds having a reduction potential suitable to accept at least one electron from said metal ion and an at least one finctional group that is able to coordinate with said metal ion.

2. The stable magnet of claim 1 wherein said high Tc is defined as greater than about 250 K.

3. The stable magnet of claim 2 wherein said high Tc is defined as greater than about 300K.

4. The magnet of claim 3 wherein said reduction potential ranges from about −1.15V to at least about +0.9V.

5. The magnet of claim 4 wherein said reduction potentials range from about −0.7V to at least about +0.9V.

6. The magnet of claim 5 wherein said organic compound is further defined as a conjugated organic compound.

7. The magnet of claim 6 wherein said organic compounds are selected from the group consisting of polynitrile organic acceptors and quinone organic acceptors.

8. The magnets of claim 7 wherein said polynitrile organic acceptors are selected from the group consisting of 7,7,8,8-Tetracyanoquinodimethane (TCNQ) and derivatives thereof, Tetracyanoethylene (TCNE), N,N′-Dicyanoquinone Diimine (DCNQI) and derivatives thereof, hexacyanodivinylbenzenes, dicyanostilbenes, and phenyltricyanoethylenes wherein the derivatives comprise R.sub. 1-R.sub.5 and are selected independently from H, C.sub.1-c.sub.20, aromatic groups, CN, F, Cl, Br, I, NO.sub.2, COOH, COOR, CHO wherein R is C.sub.1-C.sub.20, OH, OR, wherein R is C.sub.1-C.sub.20, and heteroaromatics comprising N, O, P, or S and the quinone organic acceptors are selected from the group consisting of 1,4 benzoquinone derivatives, 1,4 napthoquinone derivatives, diquinone derivatives and 1,2 benzoquinone derivatives, wherein the derivatives comprise comprise R.sub.1-R.sub.6 and are selected independently from H, C.sub.1-c.sub.20, aromatic groups, CN, F, Cl, Br, I, NO.sub.2, COOH, COOR, CHO wherein R is C.sub.1-C.sub.20, OH, OR, wherein R is C.sub.1-C.sub.60, and heteroaromatics comprising N, O, P, or S.

9. The magnet of claim 8 wherein said metal ion is selected from Nickel (Ni) and Cobalt (Co).

10. The magnet of claim 9 wherein said metal ion is Nickel.

11. The magnet of claim 10 wherein said metal ion to organic molecule ratio is about 2:1.

12. The magnet of claim 11 wherein said organic molecule is selected from the group consisting of TCNE, 2,3-dichloro-5,6-dicyano-1,4-benzoquinone (DDQ), TCNQ and TCNQ derivatives, wherein the derivatives comprise R.sub.1-R.sub.4 and are selected independently from H, C.sub.1-c.sub.20, aromatic groups, CN, F, Cl, Br, I, NO.sub.2, COOH, COOR, CHO wherein R is C.sub.1-C.sub.20, OH, OR, wherein R is C.sub.1-C.sub.20, and heteroaromatics comprising N, O, P, or S.

13. The magnet of claim 12 wherein said organic molecule is selected from the group consisting of TCNE, DDQ and TCNQ.

14. The magnet of claim 13 wherein nickel and the organic molecule are in a final ratio of approximately 2:1 in the magnet.

15. A stable magnet having a Tc greater than about 250K comprising metal ions from a metal-containing precursor and molecules of an organic compound, wherein said metal ion is provided at a valency lower than its maximum valency state, and
said molecules are selected from a group of organic compounds having a reduction potential suitable to accept at least one electron from said metal ion and an at least one functional group that is able to coordinate with said metal ion.

16. The stable magnet of claim 15 wherein said high Tc is defined as greater than about 300K.

17. The magnet of claim 16 wherein said reduction potential ranges from about −1.15V to at least about +0.9V.

18. The magnet of claim 17 wherein said reduction potential ranges from about −0.9V to at least about +0.9V.

19. The magnet of claim 18 wherein said reduction potentials range from about −0.7V to at least about +0.9V.

20. The magnet of claim 19 wherein said organic compound is further defined as a conjugated organic compound.

21. The magnet of claim 20 wherein said organic compounds are selected from the group consisting of polynitrile organic acceptors and quinone organic acceptors.

22. The magnet of claim 21 wherein said polynitrile organic acceptors are selected from the group consisting of 7,7,8,8-Tetracyanoquinodimethane (TCNQ) and derivatives thereof, Tetracyanoethylene (TCNE), N,N′-Dicyanoquinone Diimine (DCNQI) and derivatives thereof, hexacyanodivinylbenzenes, dicyanostilbenes, and phenyltricyanoethylenes wherein the derivatives comprise R.sub.1-R.sub.5 and are selected independently from H, C.sub.1-c.sub.20, aromatic groups, CN, F, Cl, Br, I, NO.sub.2, COOH, COOR, CHO wherein R is C.sub.1-C.sub.20, OH, OR, wherein R is C.sub.1-C.sub.20, and heteroaromatics comprising N, O, P, or S and the quinone organic acceptors are selected from the group consisting of 1,4 benzoquinone derivatives, 1,4 napthoquinone derivatives, diquinone derivatives and 1,2 benzoquinone derivatives, wherein the derivatives comprise comprise R.sub.1 -R.sub.6 and are selected independently from H, C.sub.1-c.sub.20, aromatic groups, CN, F, Cl, Br, I, NO.sub.2, COOH, COOR, CHO wherein R is C.sub.1-C.sub.20, OH, OR, wherein R is C.sub.1-C.sub.60, and heteroaromatics comprising N, O, P, or S.

23. The magnet of claim 22 wherein said metal ion is selected from Nickel (Ni),and Cobalt (Co).

24. The magnet of claim 23 wherein said metal ion is Nickel.

25. The magnet of claim 24 wherein said organic molecule is selected from the group consisting of TCNE, 2,3-dichloro-5,6-dicyano-1,4-benzoquinone (DDQ), TCNQ and TCNQ derivatives, wherein the derivatives comprise R.sub.1-R.sub.4 and are selected independently from H, C.sub.1-c.sub.20, aromatic groups, CN, F, Cl, Br, I, NO.sub.2, COOH, COOR, CHO wherein R is C.sub.1-C.sub.20, OH, OR, wherein R is C.sub.1-C.sub.20, and heteroaromatics comprising N, O, P, or S.

26. The magnet of claim 25 wherein said organic molecule is selected from the group consisting of TCNE, DDQ and TCNQ.

27. The magnet of claim 26 wherein nickel and the organic molecule are in a final ratio of about 2:1 in the magnet.

28. A method of preparing a stable magnet having a high Tc, said method comprising reacting metal ions of a metal-containing precursor and molecules of an organic compound in a metal to organic ratio,
said metal to organic ratio being at least about 1 ion to 1 organic molecule,
said metal ions being in a valency state lower than their maximum valency state, and
said molecules selected from a group of organic compounds having a reduction potential suitable to accept at least one electron from said metal ion and functional groups that are able to coordinate with said metal ion.

29. The method of claim 28 wherein said high Tc is defined as greater than about 250 K.

30. The stable magnet of claim 29 wherein said high Tc is defined as greater than about 300K.

31. The method of claim 30 wherein said reduction potential ranges from about −1.15V to at least about +0.9V.

32. The method of claim 31 wherein said reduction protentials range from about −0.7V to at least about +0.9V.

33. The method of claim 32 wherein said organic molecule is further defined as a conjugated molecule.

34. The method of claim 33 wherein said organic compounds are selected from the group consisting of polynitrile organic acceptors and quinone organic acceptors.

35. The method of claim 34 wherein said polynitrile organic acceptors are selected from the group consisting of 7,7,8,8-Tetracyanoquinodimethane (TCNQ) and derivatives thereof, Tetracyanoethylene (TCNE), N,N′-Dicyanoquinone Diimine (DCNQI) and derivatives thereof, hexacyanodivinylbenzenes, dicyanostilbenes, and phenyltricyanoethylenes wherein the derivatives comprise R.sub.1-R.sub.5 and are selected independently from H, C.sub.1-c.sub.20, aromatic groups, CN, F, Cl, Br, I, NO.sub.2, COOH, COOR, CHO wherein R is C.sub.1-C.sub.20, OH, OR, wherein R is C.sub.1-C.sub.20, and heteroaromatics comprising N, O, P, or S and the quinone organic acceptors are selected from the group consisting of 1,4 benzoquinone derivatives, 1,4 napthoquinone derivatives, diquinone derivatives and 1,2 benzoquinone derivatives, wherein the derivatives comprise comprise R.sub.1-R.sub.6 and are selected independently from H, C.sub.1-c.sub.20, aromatic groups, CN, F, Cl, Br, I, NO.sub.2, COOH, COOR, CHO wherein R is C.sub.1-C.sub.20, OH, OR, wherein R is C.sub.1-C.sub.60, and heteroaromatics comprising N, O, P, or S.

36. The method of claim 35 wherein said metal ion is selected from Nickel (Ni) and Cobalt (Co).

37. The method of claim 36 wherein said metal ion is Nickel.

38. The method of claim 37 wherein said metal ion to organic molecule ratio is about 2:1.

39. The method of claim 38 wherein said organic molecule is selected from the group consisting of TCNE, 2,3-dichloro-5,6-dicyano-1,4-benzoquinone (DDQ), TCNQ and TCNQ derivatives, wherein the derivatives comprise R.sub.1-R.sub.4 and are selected independently from H, C.sub.1-c.sub.20, aromatic groups, CN, F, Cl, Br, I, NO.sub.2, COOH, COOR, CHO wherein R is C.sub.1-C.sub.20, OH, OR, wherein R is C.sub.1-C.sub.20, and heteroaromatics comprising N, O, P, or S.

40. The method of claim 39 wherein said organic molecule is selected from the group consisting of TCNE, DDQ and TCNQ.

41. The method of claim 40 wherein nickel and the organic molecule are in a final ratio of about 2:1 in the magnet.

42. A magnet having a high Tc, synthesized from metal ions of a metal-containing precursor and organic molecules having a conjugated framework, in a metal to organic ratio,
said metal to organic ratio being at least about 1 ion to 1 organic molecule on an ion to molecule basis,
said ions selected from Nickel (Ni), and Cobalt (Co), in valencies lower than their maximum valency state,
said organic compounds being selected from the group consisting of organic compounds having functional groups that are able to coordinate or bond with said metal ion.

43. The magnet of claim 42 wherein said high Tc is defined as greater than about 250 K.

44. The stable magnet of claim 43 wherein said high Tc is defined as greater than about 300K.

45. The magnet of claim 44 wherein said organic molecules have a reduction potential ranging from about −1.15V to at least about +0.9V.

46. The magnet of claim 45 wherein said organic molecules have a reduction potential ranging from about −0.7V to at least about +0.9V.

47. A magnet having a Tc greater.than 250K, comprising metal ions from a metal-containing precursors and organic molecules having a conjugated framework, said ions selected from Nickel (Ni), and Cobalt (Co), provided in valencies lower than their maximum valency state, said organic compounds being selected from the group consisting of organic compounds having functional groups that are able to coordinate with said metal ion.

48. The stable magnet of claim 47 wherein said high Tc defined as is greater than about 300K.

49. The magnet of claim 48 wherein said organic molecules have a reduction potential ranging from about −1.15V to at least about +0.9V.

50. The magnet of claim 49 wherein said organic molecules have a reduction potential ranging from about −0.7V to at least about +0.9V.

51. A method of preparing a magnet having a high Tc, said method comprising synthesizing said magnet from metal ions of a metal-containing precursor and organic molecules having a conjugated framework, in a metal to organic ratio,
said metal to organic ratio being at least about 1 ion to 1 organic molecule on an ion to molecule basis,
said ions selected from Nickel (Ni), and Cobalt (Co), in valencies lower than their maximum valency state,
said organic compounds being selected from the group consisting of organic compounds having functional groups that are able to coordinate or bond with said metal ion.

52. The method of claim 51 wherein said high Tc is defined as greater than about 250 K.

53. The method of claim 52 wherein said high Tc is defined as greater than about 300K

54. The method of claim 53 wherein said organic molecules have a reduction potential ranging from about −1.15V to at least about +0.9V.

55. The method of claim 54 wherein said organic molecules have a reduction potential ranging from about −0.7V to at least about +0.9V.
